(19) United States
(12) Patent Application Publication
(10) Pub. No.: US 2025/0335778 A1
(43) Pub. Date: Oct. 30, 2025

(54) METHOD OF REMOVING HALLUCINATION IN RESULT OF INFERENCE BY NEURAL NETWORK MODEL, AND ELECTRONIC APPARATUS FOR PERFORMING THE SAME

(71) Applicant: SAMSUNG ELECTRONICS CO., LTD., Suwon-si (KR)

(72) Inventors: Dongseop LEE, Suwon-si (KR); Heejun Song, Suwon-si (KR); Jiyeon Lee, Suwon-si (KR); Wonho Ryu, Suwon-si (KR); Hoonyoung Cho, Suwon-si (KR)

(73) Assignee: SAMSUNG ELECTRONICS CO., LTD., Suwon-si (KR)

(21) Appl. No.: 19/198,638

(22) Filed: May 5, 2025

Related U.S. Application Data
(63) Continuation of application No. PCT/KR2025/005618, filed on Apr. 25, 2025.

(30) Foreign Application Priority Data
Apr. 25, 2024 (KR) 10-2024-0055579

(51) Int. Cl. G06N 3/091; G06F 40/20

(52) U.S. Cl. CPC G06N 3/091; G06F 40/20

(57) ABSTRACT

A method of removing a hallucination in a result of inference by a neural network model may include obtaining a response of a neural network model based on a prompt provided to the neural network model; determining, based on a context comprised in the prompt, whether a hallucination has occurred in the response; and based on determining that the hallucination has occurred, modifying the response and outputting the modified response.

### CROSS-REFERENCES TO RELATED APPLICATIONS

This application is a continuation of International Application No. PCT/KR2025/005618, filed on Apr. 25, 2025, with the Korean Intellectual Property Association, which claims priority to Korean Patent Application No. 10-2024-0055579, filed on Apr. 25, 2024, with the Korean Intellectual Property Association, the disclosures of which is incorporated herein by reference in their entireties.

### TECHNICAL FIELD

The disclosure relates to a method of removing a hallucination in a result of inference by a neural network model and an electronic apparatus for the same. In detail, the disclosure relates to a method of detecting a hallucination by assessing a response based on a context from a prompt, and modifying the response to remove the hallucination.

### BACKGROUND

Neural network models such as large language models (LLMs) are being utilized in various fields as their performance is rapidly improving. However, hallucinations may occur due to a lack of training data or input data, used to train a neural network model, or errors therein. To prevent hallucinations, methods such as improving the quality of training data or increasing the validation of input data may be used. However, despite these efforts, it is difficult to completely prevent hallucinations, so a method of detecting and removing a hallucination is required.

### SUMMARY

According to an aspect of the disclosure, a method of removing a hallucination in a result of inference by a neural network model may include obtaining a response of a neural network model based on a prompt provided to the neural network model; determining, based on a context comprised in the prompt, whether a hallucination has occurred in the response; and based on determining that the hallucination has occurred, modifying the response and outputting the modified response.

According to an aspect of the disclosure, an electronic apparatus for removing a hallucination in a result of inference by a neural network model may be provided. The electronic apparatus may include an input/output interface configured to receive a prompt to be input to a neural network model and configured to output a response of the neural network model in response to the prompt; a memory storing one or more instructions for detecting a hallucination in the response; and at least one processor comprising processing circuitry. The one or more instructions may be configured to, when executed by the at least one processor individually or collectively, cause the electronic device to obtain the response of the neural network model based on the prompt provided to the neural network model, determine, based on a context comprised in the prompt, whether a hallucination has occurred in the response, and based on determining that the hallucination has occurred, modify the response and output the modified response.

According to an aspect of the disclosure, a non-transitory computer-readable recording medium storing one or more instructions may be provided. The one or more instructions, when executed by one or more processors, cause the one or more processors to: obtain a response of a neural network model based on a prompt to the neural network model; determine, based on a context comprised in the prompt, whether a hallucination has occurred in the response; and based on determining that the hallucination has occurred, modify the response and outputting the modified response.

According to an aspect of the disclosure, a computer program may be stored in a non-transitory recording medium so as to perform, on a computer, the method according to at least one of the embodiments of the disclosure.

### BRIEF DESCRIPTION OF DRAWINGS

FIG. 1 is a diagram illustrating components for a method of removing a hallucination from a result of inference by a neural network model, according to an embodiment of the disclosure.

FIG. 2 is a block diagram illustrating a configuration of a response modification module, according to an embodiment of the disclosure.

FIG. 3 is a diagram illustrating a configuration of an electronic apparatus, according to an embodiment of the disclosure.

FIG. 4 is a diagram illustrating components for reinforcement learning on a neural network model based on a modified response, according to an embodiment of the disclosure.

FIG. 5 illustrates an example in which a neural network model outputs a response corresponding to a prompt, according to an embodiment of the disclosure.

FIG. 6 is a diagram illustrating an example where a context extractor extracts key contexts or key tokens from a prompt, according to an embodiment of the disclosure.

FIG. 7 is a diagram illustrating an example where an assessment item generator generates assessment items based on key contexts or key tokens, according to an embodiment of the disclosure.

FIG. 8 is a diagram illustrating an example where an assessment performer detects a hallucination by performing an assessment on a response for each assessment item, according to an embodiment of the disclosure.

FIG. 9 illustrates an example where a hallucination remover removes a hallucination in a response, according to an embodiment of the disclosure.

FIG. 10 is a diagram illustrating an example where a neural network model outputs a response corresponding to a prompt, according to an embodiment of the disclosure.

FIG. 11 is a diagram illustrating an example where a context extractor extracts a key context from a prompt, according to an embodiment of the disclosure.

FIG. 12 is a diagram illustrating an example where an assessment item generator generates an assessment item based on a key context, according to an embodiment of the disclosure.

FIG. 13 is a diagram illustrating an example where an assessment performer detects a hallucination by performing an assessment on a response for each assessment item, according to an embodiment of the disclosure.

FIG. 14 illustrates an example where a hallucination remover removes a hallucination in a response, according to an embodiment of the disclosure.

FIGS. 15 to 19 are flowcharts illustrating examples of removing a hallucination from a result of inference by a neural network model, according to embodiments of the disclosure.

### DETAILED DISCLOSURE

Throughout the disclosure, the expression “at least one of a, b or c” indicates only a, only b, only c, both a and b, both a and c, both b and c, all of a, b, and c, or variations thereof.

In the disclosure, unless the context clearly indicates otherwise, the singular forms “a, “an,” and “the” are to be understood to include a plurality of referents. Thus, for example, reference to “a surface constituting” may also include reference to one or more of such surfaces.

In describing the disclosure, descriptions of technical ideas that are well known in a technical field to which the disclosure pertains and are not directly related to the disclosure will be omitted. This is to more clearly convey the essence of the disclosure without obscuring it by omitting unnecessary descriptions. Furthermore, terms used hereinafter are defined by taking into account functions described in the disclosure and may be changed according to a user's or operator's intent, practices, or the like. Therefore, definition of the terms should be made based on the overall description of the disclosure.

For the same reason, in the accompanying drawings, some components are exaggerated, omitted, or schematically illustrated. Also, the size of each component does not entirely reflect the actual size. In the drawings, like reference numerals refer to the same or corresponding elements throughout.

Advantages and features of the disclosure and methods of accomplishing the same will be more readily appreciated by referring to the following description of embodiments of the disclosure and the accompanying drawings. However, the disclosure may be embodied in many different forms and should not be construed as being limited to the embodiments of the disclosure set forth below. Rather, the embodiments of the disclosure are provided so that the disclosure will be made thorough and complete and will fully convey the scope of the disclosure to those of ordinary skill in the art to which the disclosure pertains. An embodiment of the disclosure may be defined by the appended claims. Throughout the specification, like reference numerals refer to like elements. Furthermore, in the following description of the disclosure, related functions or configurations will not be described in detail when it is determined that they would obscure the essence of the disclosure with unnecessary detail. Furthermore, terms used hereinafter are defined by taking into account functions described in the disclosure and may be changed according to a user's or operator's intent, practices, or the like. Therefore, definition of the terms should be made based on the overall description of the disclosure.

It should be understood that blocks in each flowchart and combinations of flowcharts in the disclosure may be performed by one or more computer programs including computer-executable instructions. The one or more computer programs may be all stored in a single memory, or may be partitioned and stored in a number of different memories.

In an embodiment of the disclosure, each block in flowchart illustrations and combinations of the flowchart illustrations may be performed by computer program instructions. These computer program instructions may be loaded into a processor of a general-purpose computer, a special-purpose computer, or other programmable data processing equipment, and the instructions executed by the processor of the computer or the other programmable data processing equipment may generate a unit for performing functions specified in the flowchart block(s). The computer program instructions may also be stored in a computer-executable or computer-readable memory capable of directing the computer or the other programmable data processing equipment to implement functions in a directed manner, and the instructions stored in the computer-executable or computer-readable memory are capable of producing an article of manufacture including instructions for performing the functions specified in the flowchart block(s). The computer program instructions may also be loaded into the computer or the other programmable data processing equipment.

In addition, each block of a flowchart may represent a module, segment, or portion of code that includes one or more executable instructions for executing specified logical function(s). In an embodiment of the disclosure, functions mentioned in blocks may occur out of order. For example, two blocks illustrated in succession may be executed substantially simultaneously, or the blocks may sometimes be executed in reverse order depending on functions corresponding thereto.

All functions or operations described herein may be processed by a single processor or a combination of processors. The processor or combination of processors is circuitry that performs processing, and may include circuitry such as an application processor (AP), a communication processor (CP), a graphics processing unit (GPU), a neural processing unit (NPU), a microprocessor unit (MPU), a system on chip (SoC), an integrated chip (IC), and the like.

As used in an embodiment of the disclosure, the term ‘unit’ refer to a software element or a hardware element such as a field-programmable gate array (FPGA) or an application-specific integrated circuit (ASIC), and may perform a predetermined function. However, the term ‘unit’ is not limited to software or hardware. The ‘unit’ may be configured to be in an addressable storage medium or configured to operate one or more processors. In an embodiment of the disclosure, the term ‘unit’ may include elements such as software elements, object-oriented software elements, class elements, and task elements, processes, functions, attributes, procedures, sub-routines, segments of program code, drivers, firmware, micro-codes, circuitry, data, a database, data structures, tables, arrays, and parameters. Functions provided by a particular element or unit may be combined to reduce the number of elements or may be further divided into additional elements. In addition, in an embodiment of the disclosure, a ‘unit’ may include one or more processors.

Hereinafter, embodiments of the disclosure are described in detail with reference to the drawings.

In the disclosure, when a prompt is input to a neural network model and a response is output, an electronic apparatus according to an embodiment of the disclosure may determine whether a hallucination has occurred in the response by assessing the response based on the prompt. When the hallucination has occurred in the response, modify the response and output the modified response. In detail, the electronic apparatus may determine whether an error is included in the response by assessing the response according to an assessment item determined based on a context included in the prompt. In embodiments, when the error is included in the response, output a modified response by removing the error in the response.

Furthermore, according to an embodiment of the disclosure, the electronic apparatus may provide feedback to the neural network model by using the modified response, thereby improving the reliability of the neural network model. In detail, the electronic apparatus may retrain the neural network model by using training data including the prompt and the modified response.

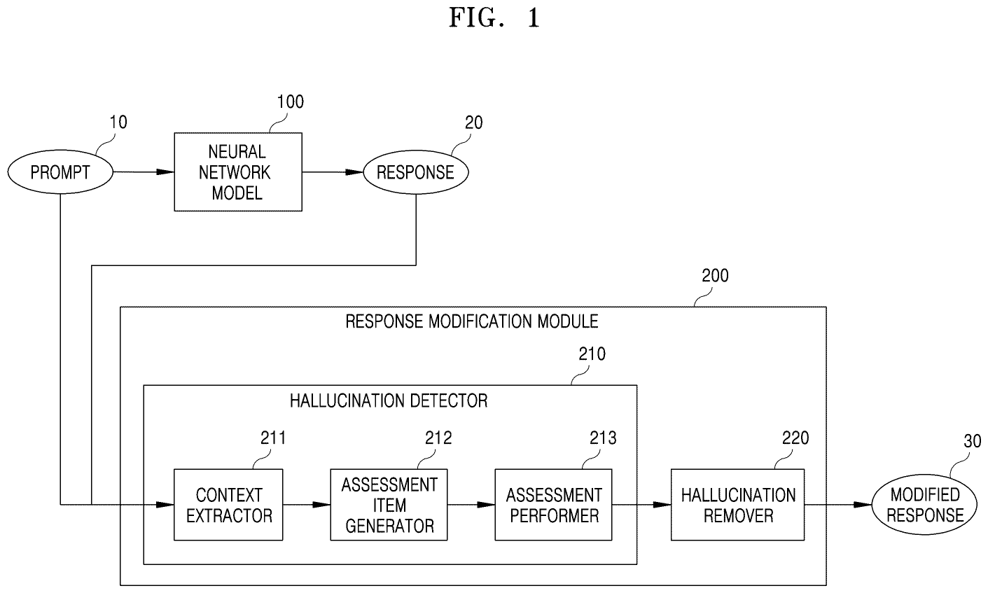

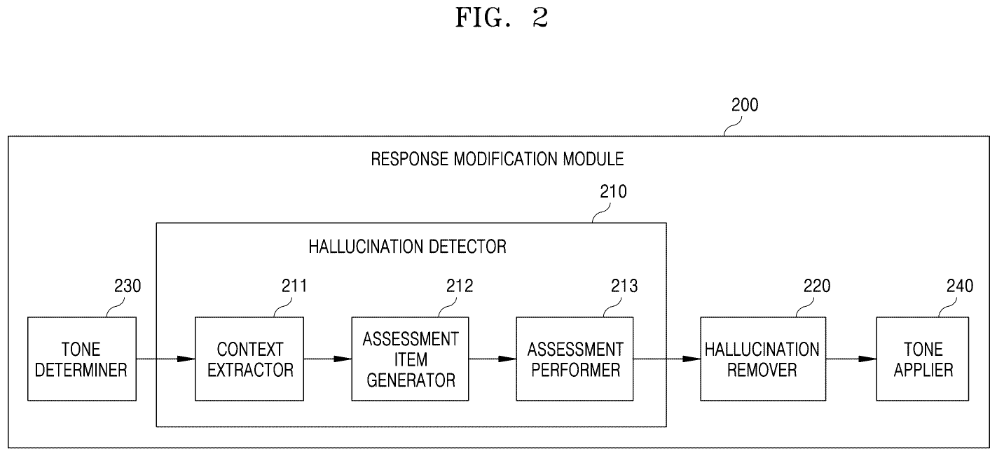

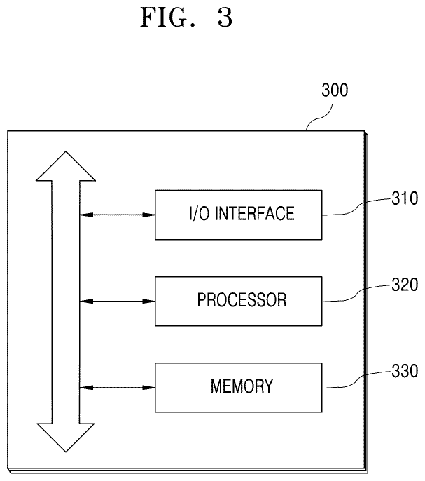

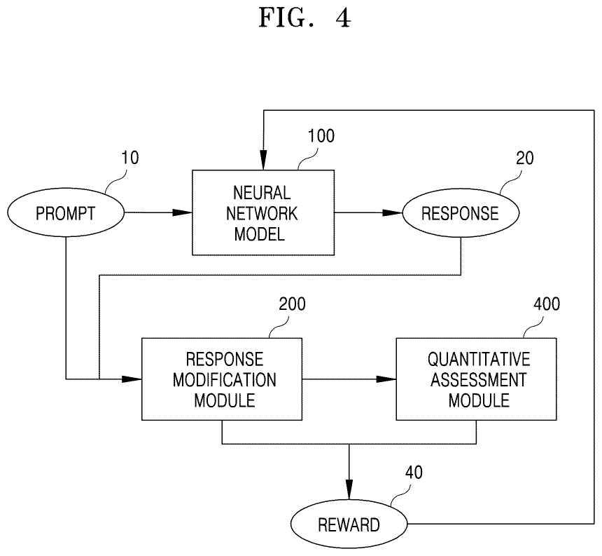

First, a process of detecting and removing a hallucination in a response is described in general with reference to FIGS. 1 and 2, a configuration of an electronic apparatus that performs the operation of detecting and removing a hallucination in a response is described with reference to FIG. 3, and then a process of retraining a neural network model based on a modified response is described with reference to FIG. 4.

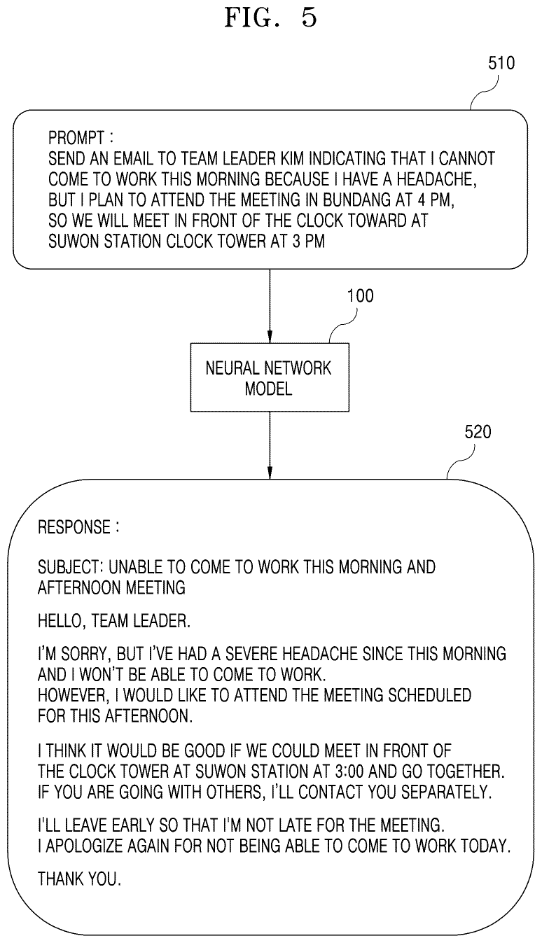

Thereafter, a process of detecting and removing hallucinations is described in detail by using exemplary prompts and responses as illustrated in FIGS. 5 to 14.

### 1. Detecting and Removing Hallucination from Response Based on Context Included in Prompt

FIG. 1 is a diagram illustrating components for performing a method of removing a hallucination from a result of inference by a neural network model, according to an embodiment of the disclosure. Referring to FIG. 1, a process of detecting and removing a hallucination from a response 20 output in response to a prompt 10 is described.

A neural network model 100, a response modification module 200, and detailed components, i.e., a hallucination detector 210, a context extractor 211, an assessment item generator 212, an assessment performer 213, and a hallucination remover 220, included in the response modification module 200, are illustrated in FIG. 1. The components may be differentiated based on their functions or roles. The above components, i.e., the neural network model 100 to the hallucination remover 220, illustrated in FIG. 1 may be software components implemented by a processor 320 of an electronic apparatus 100 of FIG. 3, as described below, executing a program stored in a memory 330, or may also be virtual components for which no actual matching hardware devices exist. In other words, operations that the processor 320 of the electronic apparatus 300 performs by executing the program stored in the memory 330 may be classified into a plurality of groups according to function or purpose, and entities that perform the operations respectively included in the plurality of groups may be represented as the components of FIG. 1, i.e., the neural network model 100 to the hallucination remover 220. Accordingly, the operations described as being performed by the components of FIG. 1, i.e., the neural network model 100 to the hallucination remover 220, may be considered as actually being performed by the processor 320 of the electronic apparatus 300 executing the program stored in the memory 330.

At least one of the components, elements, modules and units (collectively “components” in this paragraph) represented by a block in the drawings such as FIGS. 1, 2, 8, 9, 13, and 14 may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU), a microprocessor, or the like that performs the respective functions.

Referring to FIG. 1, according to an embodiment of the disclosure, when a prompt 10 is input to the neural network model 100, the neural network model 100 may perform inference and output a response 20. According to an embodiment of the disclosure, the neural network model 100 may be configured to include a large language model (LLM) to answer questions, perform an operation according to a request (e.g., writing an email), or perform translation or summarization, etc. However, the neural network model 100 is not limited thereto, and may be a model that has various forms of inputs and outputs and is trained to perform operations for various purposes. The prompt 10 or the response 20 may be in the form of text, an image, or various other forms of inputs and outputs.

Hallucinations may occur in the response 20 due to a lack of or errors in training data or input data (the prompt 10) used in training the neural network model 100, or due to various other causes. For example, the response 20 may contain incorrect information. Alternatively, for example, matters requested in the prompt 10 may not be reflected in the response, or conversely, matters not requested in the prompt 10 may be included in the response 20. In addition, hallucinations may occur in various other forms, such as the response 20 being generated to include information that does not fit a context of the prompt 10 or is false information.

To prevent hallucinations, methods such as improving the quality of training data or increasing the validation of input data may be used. However, despite these efforts, it is difficult to completely prevent hallucinations, so in embodiments of the disclosure, the electronic apparatus may detect and remove a hallucination in the response 20.

The response modification module 200 may detect a hallucination in the response 20 and output a modified response 30 by removing the detected hallucination.

The response modification module 200 may include the hallucination detector 210 and the hallucination remover 220, and the hallucination detector 210 may include the context extractor 211, the assessment item generator 212, and the assessment performer 213.

An input and an output of the neural network model 100, i.e., the prompt 10 and the response 20, may be input to the response modification module 200. According to an embodiment of the disclosure, the response modification module 200 may determine, based on the context included in the prompt 10, whether a hallucination has occurred in the response 20, and when the hallucination has occurred, remove the hallucination.

An embodiment a method by which the hallucination detector 210 detects a hallucination in the response 20 is described below.

The context extractor 211 may extract a context from the prompt 10. According to an embodiment of the disclosure, the context extractor 211 may extract at least one key context or key token from the prompt 10.

A key context may refer to an important context among contexts included in the prompt 10. The key context may be a context that directly affects the generation of the response 20. Therefore, the key context may be used to determine whether a hallucination has occurred in the response 20.

A key token may refer to an important token among tokens included in the prompt 10 and may be extracted from a key context. The key token may also be a token that directly affects the generation of the response 20. Therefore, the key token may be used to determine whether a hallucination has occurred in the response 20.

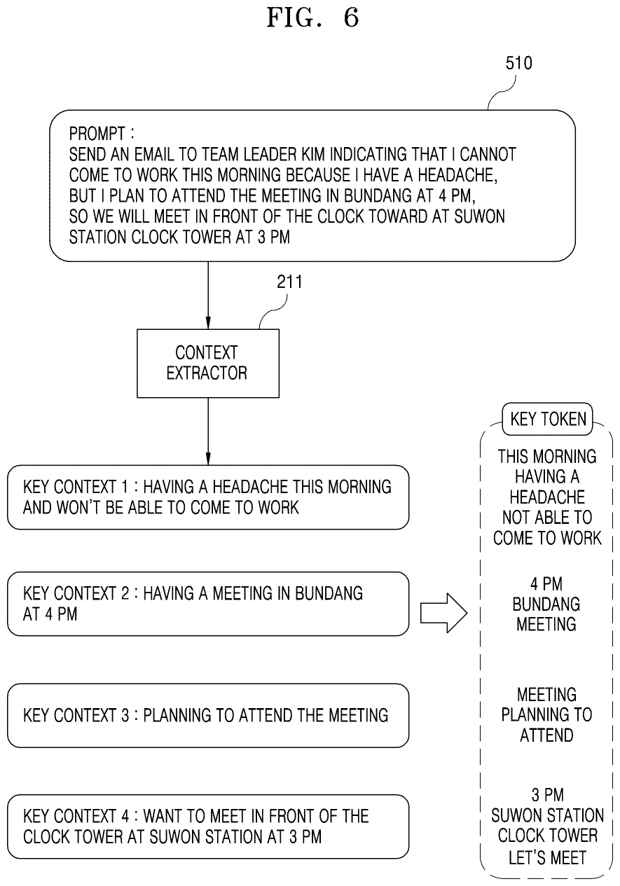

An embodiment of extracting a key context or key token from the prompt 10 is described in detail below with reference to FIG. 6.

The assessment item generator 212 may generate an assessment item based on the extracted context. For example, the assessment item generator 212 may generate at least one assessment item based on the at least one key context or key token extracted from the prompt 10.

The assessment item generator 212 may generate an assessment list including a plurality of assessment items and may assign priorities to the plurality of assessment items. When priorities are assigned to the plurality of assessment items, the assessment performer 213 may determine whether a hallucination has occurred by performing an assessment for each of the assessment items by applying a weight corresponding to a priority to the corresponding assessment item.

An assessment item may include information that needs to be checked to determine whether a hallucination has occurred. For example, the assessment item may include checking whether information is included in the response 20, and when the information is not included therein, determining that a hallucination has occurred in the response 20. In addition, the assessment item may include determining whether a hallucination has occurred based on various other criteria or rules. An embodiment of method of generating an assessment item based on the context extracted from the prompt 10.

According to an embodiment of the disclosure, the assessment item generator 212 may determine information to be included in the response 20 based on a key context or key token, and may generate an assessment item for determining that a hallucination has occurred when the determined information is not included in the response 20. For example, when the neural network model 100 provides an email writing service, the assessment item generator 212 may determine information to be included in an email (the response 20) based on a key context or key token extracted from the prompt 10. Accordingly, the assessment item generator 212 may generate an assessment item for determining that a hallucination has occurred when the determined information is not included in the email (the response 20).

According to an embodiment of the disclosure, the assessment item generator 212 may generate an assessment item for determining that a hallucination has occurred when the response 20 does not include content corresponding to a key context or key token. For example, when the neural network model 100 provides a question answering service, the assessment item generator 212 may generate an assessment item for determining that a hallucination has occurred when the response 20 does not include an answer to a question (a key context or key token) included in the prompt 10.

According to an embodiment of the disclosure, the assessment item generator 212 may generate an assessment item for determining that a hallucination has occurred when the response 20 includes content that is inconsistent with a key context or key token. For example, when the neural network model 100 provides a service for translating or summarizing text, the assessment item generator 212 may generate an assessment item for determining that a hallucination has occurred when the response 20 includes content that is inconsistent with content (a key context or key token) of the text to be translated or summarized.

According to an embodiment of the disclosure, the assessment item generator 212 may check a reference document (a source document) used to generate the response 20 based on a key context or key token, and generate an assessment item for determining that a hallucination has occurred when the response 20 includes content that is inconsistent with the reference document. For example, when the neural network model 100 provides a question answering service, the assessment item generator 212 may check a document that the neural network model 100 referenced when generating an answer to a question included in the prompt 10, and generate an assessment item for determining that a hallucination has occurred when the response 20 includes content that is inconsistent with the referenced document.

The assessment performer 213 may perform an assessment on the response 20 for each assessment item, and determine whether a hallucination has occurred in the response 20 based on an assessment result. According to an embodiment of the disclosure, when the response 20 does not satisfy a condition required by an assessment item, the assessment performer 213 may determine that the assessment result is ‘failure’. On the other hand, when the response 20 satisfies the condition required by the assessment item, the assessment performer 213 may determine that the assessment result is ‘success’.

When there is only one assessment item output from the assessment item generator 212, the assessment performer 213 may determine whether a hallucination has occurred by considering only an assessment result for the corresponding assessment item. According to an embodiment of the disclosure, when the assessment result for the assessment item is ‘success’, the assessment performer 213 may determine that no hallucination has occurred in the response 20, and conversely, when the assessment result for the assessment item is ‘failure’, the assessment performer 213 may determine that a hallucination has occurred in the response 20. For example, the assessment performer 213 may determine whether information is included in the response 20 depending on an assessment item, and when the information is not included therein, determine that a hallucination has occurred in the response 20.

As described above, there may be a plurality of assessment items generated by the assessment item generator 212. When there are a plurality of assessment items output from the assessment item generator 212, the assessment performer 213 may perform an assessment for each assessment item and then determine whether a hallucination has occurred in the response 20 by comprehensively considering assessment results for the assessment items. For this purpose, rules or criteria may be prepared for determining whether a hallucination has occurred based on the assessment results for the plurality of assessment items.

According to an embodiment of the disclosure, when there are a plurality of assessment items, the assessment performer 213 may determine that a hallucination has occurred when an assessment result for any of the plurality of assessment items is ‘failure’.

Alternatively, according to an embodiment of the disclosure, when there are a plurality of assessment items, the assessment performer 213 may obtain a result (e.g., a score) of performing an assessment for each assessment item, and determine whether a hallucination has occurred in the response 20 by comparing a sum of assessment results (assessment scores) with a preset threshold.

For example, it may be assumed that when a condition (e.g., “Does the response 20 contain specific information?”) required by an assessment item is satisfied, an assessment result (an assessment score) is 0, and when the condition required by the assessment item is not satisfied, the assessment result (assessment score) is 1. The assessment performer 213 may perform assessments on the response 20 for the plurality of assessment items, sum all the assessment results (0 or 1) respectively obtained for the assessment items, and compare a sum with a preset threshold (e.g., 2). The assessment performer 213 may determine that a hallucination has occurred in the response 20 when the sum of all the assessment results is greater than the preset threshold.

As described above, the plurality of assessment items generated by the assessment item generator 212 may be given priorities, and the assessment performer 213 may perform an assessment by applying a weight corresponding to a priority to each of the assessment items.

For example, the assessment performer 213 may determine whether a hallucination has occurred by multiplying an assessment result (an assessment score) for each of the assessment items by a weight corresponding to the assessment item, and then comparing, with a preset threshold, a result of summing all the assessment results (assessment scores) multiplied by the corresponding weights.

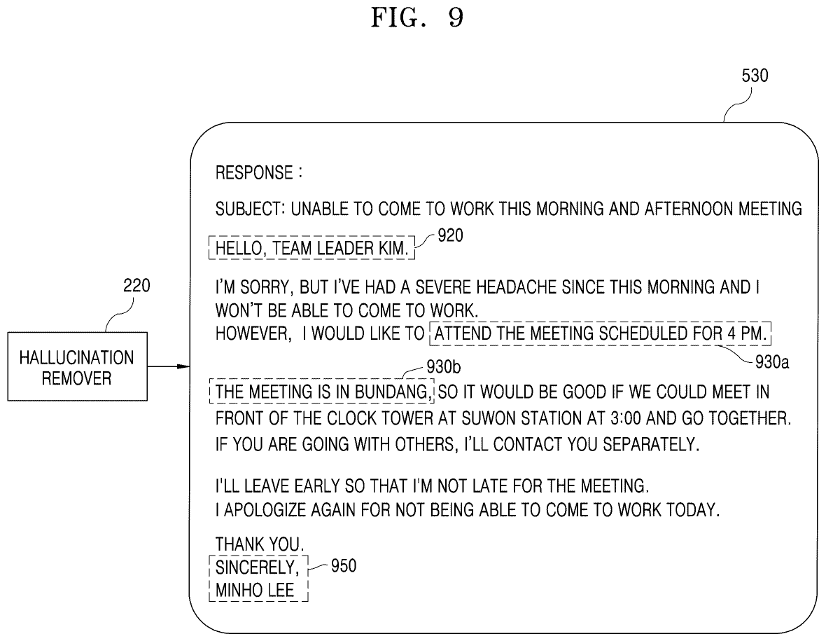

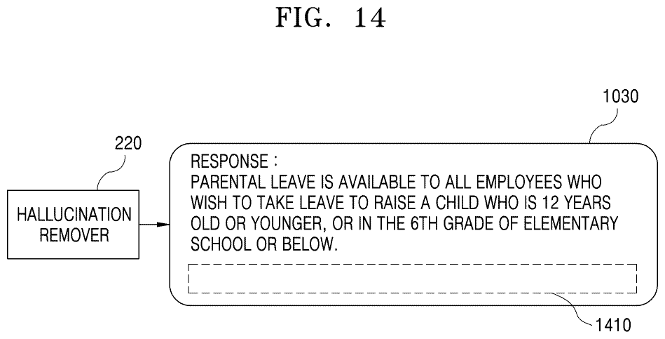

When the hallucination detector 210 determines that a hallucination has occurred in the response 20, the hallucination remover 220 may remove the hallucination by modifying the response 20. According to an embodiment of the disclosure, the hallucination remover 220 may remove the hallucination by modifying the response 20 based on at least one of a context (a key context or key token) or an assessment item. An exemplary method by which the hallucination remover 220 modifies the response 20 is described in detail below with reference to examples illustrated in FIGS. 9 and 14.

The response modification module 200 may output the modified response 30 from which the hallucination is removed.

### 2. Applying Tone Determined Based on Prompt to Response

According to an embodiment of the disclosure, the response modification module 200 may further include components for changing a tone of the response 20. FIG. 2 illustrates a configuration of the response modification module 200 according to an embodiment of the disclosure.

Referring to FIG. 2, the response modification module 200 may further include a tone determiner 230 and a tone applier 240 in comparison to the embodiment of the disclosure illustrated in FIG. 1.

The tone determiner 230 may determine a tone to be applied to the response 20, based on the context included in the prompt 10. The tone determiner 230 may determine a tone to be applied to the response 20, based on one or more factors that are to be determined or predicted according to a context in the prompt 10.

According to an embodiment of the disclosure, the tone determiner 230 may determine a tone to be applied to the response 20, based on a target to whom the response 20 is to be provided.

For example, the tone determiner 230 may infer, based on the context included in the prompt 10, a relationship between a user (a requester) who inputs the prompt 10 and a target (a recipient) to whom the response 20 is to be provided, and determine a tone according to the inferred relationship. The tone determiner 230 may determine a tone to be applied to the response 10 based on who of the recipient and the requester is older. Alternatively, the tone determiner 230 may determine a tone to be applied to the response 10, based on the relationship between the recipient and the requester (e.g., a superior-subordinate relationship in a company, a teacher-student relationship, a family relationship, etc.).

Alternatively, for example, the tone determiner 230 may predict an age group of the target to whom the response 20 is to be provided, based on a context included in the prompt 10, and determine a tone according to the predicted age group.

According to an embodiment of the disclosure, the tone determiner 230 may determine a tone to be applied to the response 20, based on a tone of the prompt 10. For example, the tone determiner 230 may determine a tone so that the same tone as the tone of the prompt 10 is applied to the response 20. Alternatively, for example, the tone determiner 230 may determine a tone so that a more polite and formal tone than the tone of the prompt 10 is applied to the response 20.

According to an embodiment of the disclosure, the tone determiner 230 may determine a tone to be applied to the response 20, based on a request in the prompt 10. For example, the tone determiner 230 may identify a request in the prompt 10 based on the context included in the prompt 10 (e.g., whether the prompt 10 is a request for a response related to professional knowledge or a request to provide information in a lightly conversational format, etc.) and determine the tone according to the identified request.

Once the tone determiner 230 determines the tone to be applied to the response 20, the tone applier 240 may modify the response 20 according to the determined tone, thereby outputting the modified response 30. The tone applier 240 may receive the response 20 from which the hallucination is removed from the hallucination remover 220, and modify an expression of the response 20 according to the determined tone. For example, when the tone determined by the tone determiner 230 is a ‘friendly tone,’ the tone applier 240 may modify sentences included in the response 20 to friendly expressions and output the modified response 30.

### 3. Configuration of Electronic Apparatus

FIG. 3 is a diagram illustrating a configuration of the electronic apparatus 300, according to an embodiment of the disclosure.

According to an embodiment of the disclosure, the electronic apparatus 300 may be a computing device having computational processing capability. For example, the electronic apparatus 300 may be a server managed by a service operator that provides services using a neural network model, or it may be a computing device such as a desktop or laptop. However, the electronic apparatus 300 is not limited thereto, and may be a device of various types, such as a smartphone, a tablet PC, or the like.

As previously described, the components, i.e., the neural network model 100, the response modification module 200, the hallucination detector 210, the context extractor 211, the assessment item generator 212, the assessment performer 213, the hallucination remover 220, the tone determiner 230, and the tone applier 240, illustrated in FIGS. 1 and 2 may be software components implemented by the processor 320 of the electronic apparatus 300 of FIG. 3 executing a program stored in the memory 330.

Although only one electronic apparatus 300 is illustrated in FIG. 3, according to an embodiment of the disclosure, the components illustrated in FIGS. 1 and 2 may be software components implemented by a combination of two or more electronic apparatuses.

Hereinafter, the configuration of the electronic apparatus 300 according to an embodiment of the disclosure is described. Referring to FIG. 3, the electronic apparatus 300 may include an input/output (I/O) interface 310, the processor 320, and the memory 330.

The I/O interface 310 may include an input interface (e.g., a communication port, a touch screen, a keyboard, hard buttons, a microphone, etc.) for receiving control commands or execution requests, data, etc. from the user or external device, and an output interface (e.g., a communication port, a display panel, a speaker, etc.) for outputting a result of executing an operation according to a request, or a status of the electronic apparatus 300.

According to an embodiment of the disclosure, the electronic apparatus 300 may receive a prompt from the user or external device via the I/O interface 310, and output a response generated in response to the prompt, or a modified response, via the I/O interface 310.

Although not shown in FIG. 3, according to an embodiment of the disclosure, the electronic apparatus 300 may further include a communication interface for performing wired or wireless communication with an external device or a network.

The processor 320 is a component that controls a series of processes to cause the electronic apparatus 300 to operate according to embodiments of the disclosure as described below, and may be configured as one or more processors. The one or more processors included in the processor 320 may be circuitry, such as an SoC, an integrated circuit (IC), or the like. The one or more processors included in the processor 320 may be general-purpose processors such as a central processing unit (CPU), an MPU, an AP, a digital signal processor (DSP), etc., dedicated graphics processors such as a GPU and a vision processing unit (VPU), dedicated AI processors such as an NPU, or dedicated communication processors such as a communication processor (CP). When the one or more processors included in the processor 320 are a dedicated AI processor, the corresponding AI dedicated processor may be designed with a hardware structure specialized for processing an AI model.

The processor 320 may write data to the memory 330 or read data stored in the memory 330, and in particular, execute a program or at least one instruction stored in the memory 330 to process data according to predefined operation rules or AI models. Thus, the processor 320 may perform operations according to embodiments of the disclosure as described below, and the operations described as being performed by the electronic apparatus 300 or the software components (the neural network model 100 to the tone applier 240 of FIGS. 1 and 2) implemented by the electronic apparatus 300 in the embodiments of the disclosure as described below may be considered as being performed by the processor 320 unless otherwise specified.

The memory 330 is a component for storing various programs or data, and may consist of a storage medium, such as read-only memory (ROM), random access memory (RAM), a hard disk, compact disc ROM (CD-ROM), and a digital video disc (DVD), or a combination of storage media. The memory 330 may not exist separately but may be configured to be included in the processor 320. The memory 330 may consist of volatile memory, non-volatile memory, or a combination of volatile memory and non-volatile memory. The memory 330 may store a program or at least one instruction for performing operations according to embodiments of the disclosure as described below. The memory 330 may provide stored data to the processor 320 according to a request from the processor 320.

### 4. Additional Training of Neural Network Model (Feedback Based on Modified Response)

According to an embodiment of the disclosure, the neural network model 100 of FIG. 1 may be further trained based on the modified response 30. The electronic apparatus 300 may perform fine-tuning or reinforcement learning on the neural network model 100 based on the modified response 30.

The electronic apparatus 300 may perform fine-tuning by retraining the neural network model 100 based on training data including the prompt 10 and the modified response 30.

The electronic apparatus 300 may obtain a reward based on the modified response 30 and may perform reinforcement learning on the neural network model 100 based on the obtained reward. The electronic apparatus 300 may obtain a score that is a measure of a quality of the response 20 or the modified response 30 as a reward, and perform reinforcement learning on the neural network model 100 so as to increase the reward. A method, performed by the electronic apparatus 300, of performing reinforcement learning on the neural network model 100 is described in detail below with reference to FIG. 4.

FIG. 4 is a diagram illustrating components for performing reinforcement learning on the neural network model 100 based on the modified response 30, according to an embodiment of the disclosure. The neural network model 100, the response modification module 200, and the quantitative assessment module 400 may be software components implemented by the processor 320 of the electronic apparatus 300 executing a program or instruction stored in the memory 330.

The electronic apparatus 300 may obtain a reward 40, based on the modified response 30 output from the response modification module 200 and an assessment result output from the quantitative assessment module 400. The quantitative assessment module 400 may receive the modified response 30 from the response modification module 200 and calculate a score for factual consistency by performing a quantitative assessment on the modified response 30.

The electronic apparatus 300 may obtain the reward 40 by inputting, to a reward function, the score for factual consistency calculated by the quantitative assessment module 400 and the modified response 30. In this case, the reward function used may be a function that calculates a score by quantifying the faithfulness, harmlessness, and usefulness of the modified response 30. The electronic apparatus 300 may obtain a score that quantifies the quality of the response 20 or the modified response 30 by using the reward function.

The electronic apparatus 300 may perform reinforcement learning on the neural network model 100 by using the obtained reward 40. In other words, the electronic apparatus 300 may update parameters included in the neural network model 100 so as to increase the reward 40.

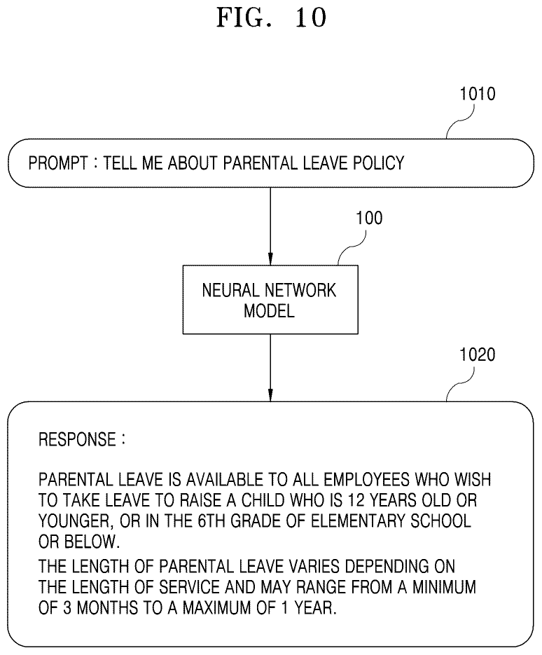

Hereinafter, a process in which the electronic apparatus 300 detects and removes a hallucination is described in detail through examples of services using the neural network model 100. An example in which the neural network model 100 writes an email according to a prompt is illustrated in FIGS. 5 to 9, and an example in which the neural network model 100 retrieves information and provides a response according to a request in a prompt is illustrated in FIGS. 10 to 14.

### 5. Embodiments of Detecting and Removing Hallucination (—e.g., FIGS. 5 to 9)

According to an embodiment of the disclosure, the neural network model 100 may perform various operations according to a request in a prompt. For example, the neural network model 100 may write an email or perform a translation or summarization according to a request in a prompt.

FIG. 5 illustrates an example in which the neural network model 100 outputs a response corresponding to a prompt, according to an embodiment of the disclosure. Referring to FIG. 5, a prompt 510 input to the neural network model 100 includes a request to write an email. The prompt 510 may be input to the electronic apparatus 300 via the I/O interface 310 of the electronic apparatus 300 or via an interface of an external device connected to the electronic apparatus 300 and then transmitted to the neural network model 100.

The neural network model 100 may output an email written according to the request in the prompt 510 as a response 520. As shown in FIG. 5, the response 520 including content requested in the prompt 510 and having a format of an email may be output from the neural network model 100.

According to an embodiment of the disclosure, the electronic apparatus 300 may not provide the user with the response 520 initially output from the neural network model 100, but may only provide the user with a response obtained after detection and removal of a hallucination is completed. However, the electronic apparatus 300 may also allow the user to see a process of modifying the response 520 by outputting the response 520 via the I/O interface 310 or an external device.

FIG. 6 is a diagram illustrating an example in which the context extractor 211 extracts key contexts or key tokens from a prompt, according to an embodiment of the disclosure. In the embodiment of the disclosure illustrated in FIG. 6, the context extractor 211 extracts four key contexts from the prompt 510. The key contexts are important contexts among contexts included in the prompt 510, and may be contexts that directly affect the generation of the response 520.

The context extractor 211 may analyze the content of the prompt 510 and extract content to be included in the email as key contexts. Referring to FIG. 6, the context extractor 211 may extract from the prompt 510 key contents that the user (the person inputting the prompt 510) wishes to convey to a recipient of the email as key contexts.

Criteria or rules for the context extractor 211 to extract key contexts from the prompt 510 may be preset, and the context extractor 211 may be implemented as a neural network model.

The context extractor 211 may also extract key tokens from the key contexts. Referring to FIG. 6, the context extractor 211 may extract key tokens by dividing each key context into a plurality of tokens.

Key tokens are important tokens among tokens included in the prompt 510, and may be tokens that directly affect the generation of the response 520. The context extractor 211 may extract key tokens directly from the prompt 510. Criteria or rules for the context extractor 211 to extract key tokens from the prompt 510 may be preset, and the context extractor 211 may be implemented as a neural network model.

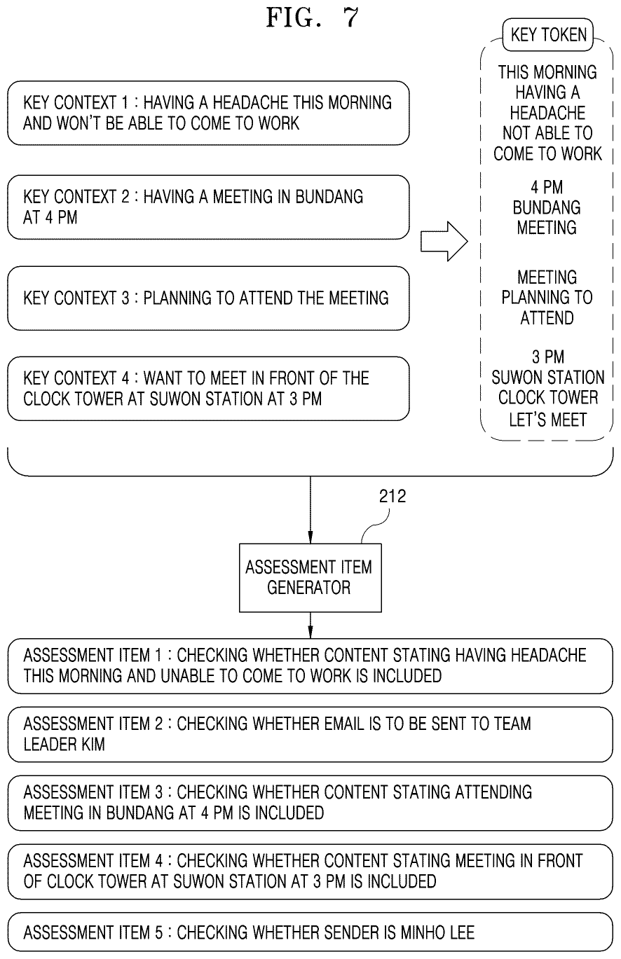

FIG. 7 is a diagram illustrating an example in which the assessment item generator 212 generates assessment items based on key contexts or key tokens, according to an embodiment of the disclosure.

Referring to FIG. 7, the assessment item generator 212 may determine information to be included in an email (the response 520) based on the key contexts or key tokens, and generate a plurality of assessment items for checking whether the determined information is included in the response 520. For this purpose, the assessment item generator 212 may generate assessment items by combining a plurality of key contexts or key tokens.

The assessment item generator 212 may generate an assessment item corresponding to each key context, generate an assessment item corresponding to two or more key contexts, or generate two or more assessment items corresponding to a single key context. In FIG. 7, the assessment item generator 212 generates one assessment item (assessment item 1) corresponding to one key context (key context 1), and generates one assessment item (assessment item 3) corresponding to two key contexts (key context 2 and key context 3).

According to an embodiment of the disclosure, the assessment item generator 212 may further generate assessment items for matters requiring verification according to services provided by the neural network model 100. Referring to FIG. 7, because the neural network model 100 provides an email writing service, the assessment item generator 212 may generate assessment items (assessment item 2 and assessment item 5) indicating verification of a recipient and a sender.

According to an embodiment of the disclosure, the assessment item generator 212 may assign priorities to the plurality of assessment items (i.e., assessment item 1 to assessment item 5). The degree to which each assessment item contributes to or affects the detection of a hallucination may be determined according to a priority given to the corresponding assessment item.

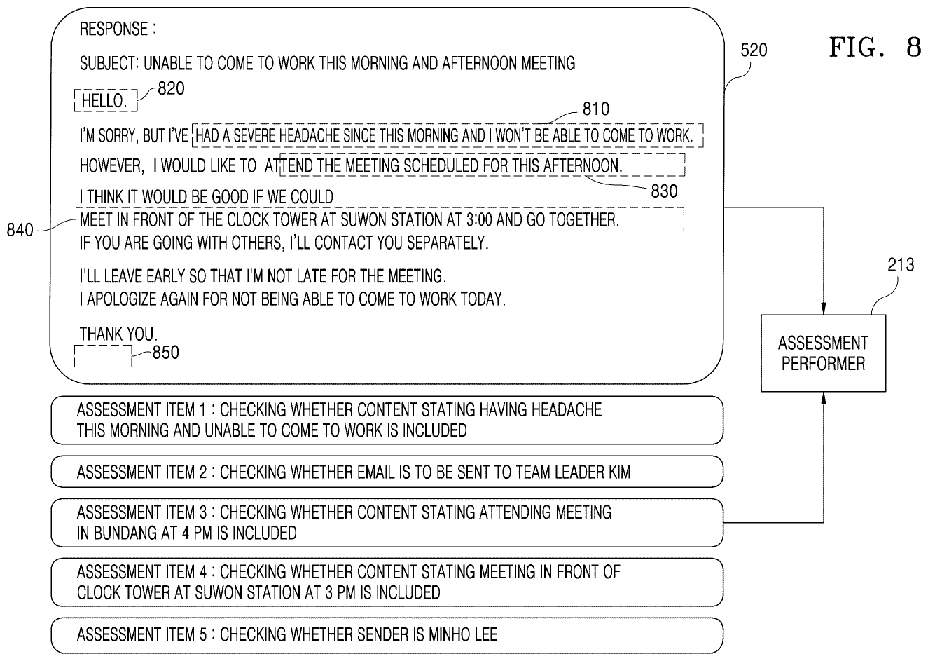

FIG. 8 is a diagram illustrating an example in which the assessment performer 213 detects a hallucination by performing an assessment on a response for each assessment item, according to an embodiment of the disclosure.

Referring to FIG. 8, the assessment performer 213 may perform an assessment on a response 520 for each of a plurality of assessment items.

The assessment performer 213 may check content stated in a first area 810 of the response 520 and determine that a condition required by assessment item 1 is satisfied. In other words, the assessment performer 213 may determine that an assessment result for assessment item 1 is ‘success’. Furthermore, the assessment performer 213 may check content stated in a fourth area 840 of the response 520 and determine that a condition required by assessment item 4 is satisfied. In other words, the assessment performer 213 may determine that an assessment result for assessment item 4 is ‘success’.

Because information about a recipient of an email is missing in a second area 820 of the response 520, the assessment performer 213 may determine that a condition required for assessment item 2 is not satisfied. In other words, the assessment performer 213 may determine that an assessment result for assessment item 2 is ‘failure’.

The assessment performer 213 may check content stated in a third area 830 of the response 520 and determine that a condition required by assessment item 3 is not satisfied. This is because, according to assessment item 3, the time (4 pm) and place (Bundang) of a meeting should be included in the response 520, but the third area 830 only states that a sender will attend a meeting to be held ‘in the afternoon’. Therefore, the assessment performer 213 may determine that an assessment result for assessment item 3 is ‘failure’.

Because information about the sender of the email is missing in a fifth area 850 of the response 520, the assessment performer 213 may determine that a condition required by assessment item 5 is not satisfied. In other words, the assessment performer 213 may determine that an assessment result for assessment item 5 is ‘failure’.

Because the assessment results for assessment items 2, 3, and 5 are each ‘failure’, the assessment performer 213 may determine that a hallucination has occurred in the response 520. As described above, the assessment execution unit 213 may determine that a hallucination has occurred in the response 520 when an assessment result of any of the plurality of assessment items (assessment item 1 to assessment item 5) is ‘failure’, or may determine whether a hallucination has occurred by respectively obtaining assessment results for the assessment items and comparing a sum of the assessment results with a previously determined threshold. In addition, the assessment execution unit 213 may determine whether a hallucination has occurred by applying a weight corresponding to a priority assigned to each assessment item.

FIG. 9 illustrates an example in which the hallucination remover 220 removes a hallucination in a response, according to an embodiment of the disclosure.

The hallucination remover 220 may remove a hallucination in the response 520 by modifying the response 520. The hallucination remover 220 may modify the response 520 based on at least one of a context (key context or key token) or an assessment item. For example, the hallucination remover 220 may modify the response 520 so that the response 520 includes a key context or a key token. Alternatively, for example, the hallucination remover 220 may modify the response 520 so as to satisfy a condition required by an assessment item.

Referring to FIG. 9, the hallucination remover 220 may add information about the recipient of the email to a second area 920 so as to satisfy the condition required by assessment item 2. Furthermore, the hallucination remover 220 may add information about the time (4 pm) and place (Bundang) of the meeting, which are the content of the key context, to a third area 930a and 930b so as to satisfy the condition required by assessment item 3. In addition, the hallucination remover 220 may add information about the sender of the email to a fifth area 950 so as to satisfy the condition required by assessment item 5.

The hallucination remover 220 may remove the hallucination by modifying the response 520 and then output a modified response 530. The electronic apparatus 300 may output the modified response 530 via the I/O interface 310 or an external device.

### 6. Exemplary Embodiment of Detecting and Removing Hallucination (e.g., FIGS. 10 to 14)

As described above, the neural network model 100 may answer a question included in a prompt or provide information requested in the prompt.

FIG. 10 is a diagram illustrating an example in which the neural network model 100 outputs a response corresponding to a prompt, according to an embodiment of the disclosure. Referring to FIG. 10, a prompt 1010 input to the neural network model 100 includes a request for information. The prompt 1010 may be input to the electronic apparatus 300 via the I/O interface 310 of the electronic apparatus 300 or via an interface of an external device connected to the electronic apparatus 300 and then transmitted to the neural network model 100.

The neural network model 100 may retrieve information according to a request in the prompt 1010 and output a result of the retrieval as a response 1020. As illustrated in FIG. 10, the response 1020 including information about a ‘parental leave policy’ requested in the prompt 1010 may be output from the neural network model 100.

According to an embodiment of the disclosure, the electronic apparatus 300 may not provide the user with the response 1020 initially output from the neural network model 100, but may only provide the user with a response obtained after detection and removal of a hallucination is completed. However, the electronic apparatus 300 may also allow the user to see a process of modifying the response 1020 by outputting the response 1020 via the I/O interface 310 or an external device.

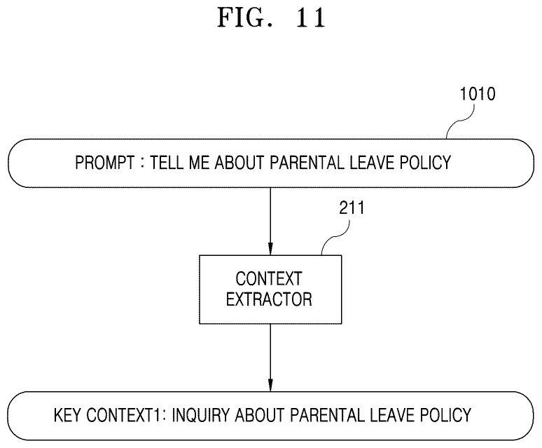

FIG. 11 is a diagram illustrating an example in which the context extractor 211 extracts a key context from a prompt, according to an embodiment of the disclosure. In the embodiment of the illustrated in FIG. 11, the context extractor 211 extracts one key context from the prompt 1010. The extracted key context may indicate what information the prompt 1010 includes an inquiry for.

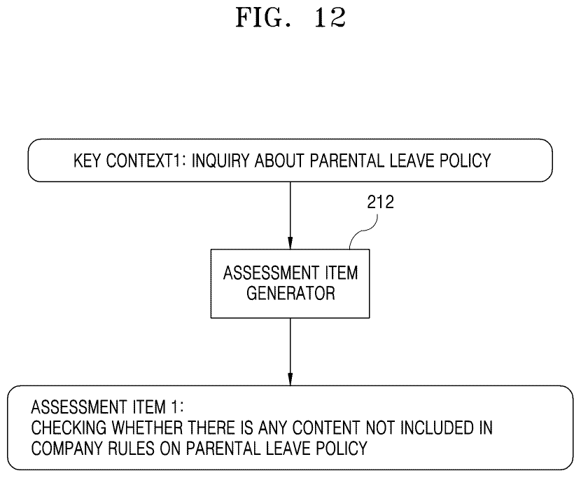

FIG. 12 is a diagram illustrating an example in which an assessment item generator generates an assessment item based on a key context, according to an embodiment of the disclosure.

Referring to FIG. 12, the assessment item generator 212 may identify, based on a key context, that a reference document used when generating the response 1020 is company rules, and generate an assessment item for checking whether the response 1020 includes content that is inconsistent with the company rules. The assessment item generator 212 may identify the reference document used by the neural network model 100 when generating the response 1020 from the Internet or a database connected to the electronic apparatus 300.

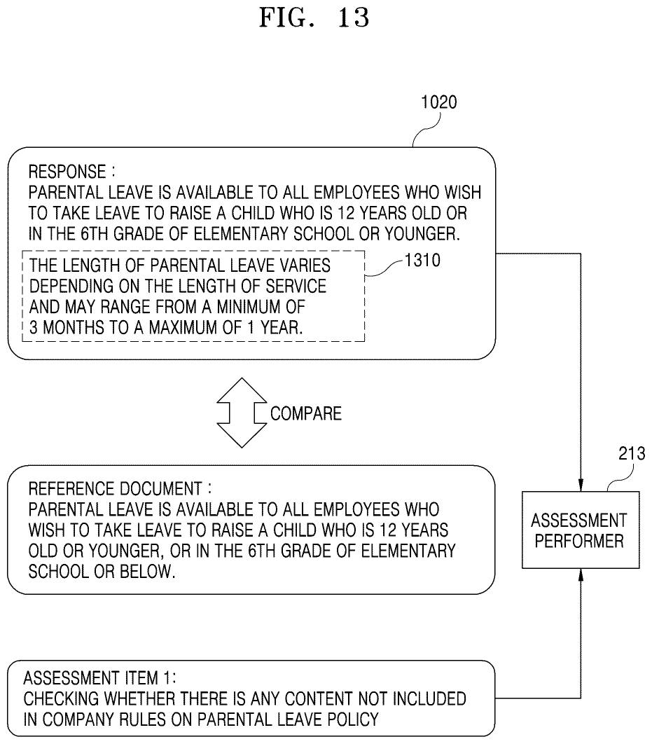

FIG. 13 is a diagram illustrating an example in which the assessment performer 213 detects a hallucination by performing an assessment on a response for each assessment item, according to an embodiment of the disclosure.

Referring to FIG. 13, the assessment performer 213 may perform an assessment on the response 1020 for assessment item 1. The assessment performer 213 may verify that content stated in a first area 1310 of the response 1020 is not included in the reference document, and determine that an assessment result for assessment item 1 is ‘failure’. Accordingly, the assessment performer 213 may determine that a hallucination has occurred in the response 1020.

FIG. 14 illustrates an example in which the hallucination remover 220 removes a hallucination in a response, according to an embodiment of the disclosure.

The hallucination remover 220 may remove a hallucination in the response 1020 by modifying the response 1020. The hallucination remover 220 may modify the response 1020 to satisfy a condition required by assessment item 1 (that the response does not include content that is not in the reference document). Referring to FIG. 14, the hallucination remover 220 may remove content that is not in the company rules from the response 1020 and output a modified response 1030. By comparing a first area 1410 of the modified response 1030 with the response 1020, it can be seen that content that is not in the company rules has been deleted.

### 7. Flowcharts for Exemplary Methods and Processes for Detecting and Removing Hallucination Based on Context Included in Prompt

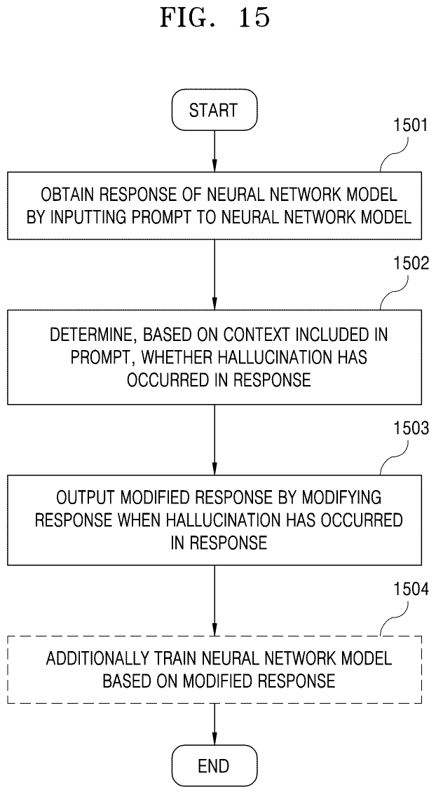

Hereinafter, a method of removing a hallucination in a result of inference by a neural network model, according to embodiments of the disclosure, is described with reference to FIGS. 15 to 19. Because operations included in the flowcharts of FIGS. 15 to 19 are performed by the components illustrated in FIGS. 1 to 4, descriptions already provided with reference to FIGS. 1 to 4 may be equally applicable to FIGS. 15 to 19 even when omitted below.

Referring to FIG. 15, in operation 1501, by inputting a prompt to a neural network model, an electronic apparatus may obtain a response of the neural network model. The neural network model may answer questions, perform an operation according to a request (e.g., writing an email), or perform translation or summarization.

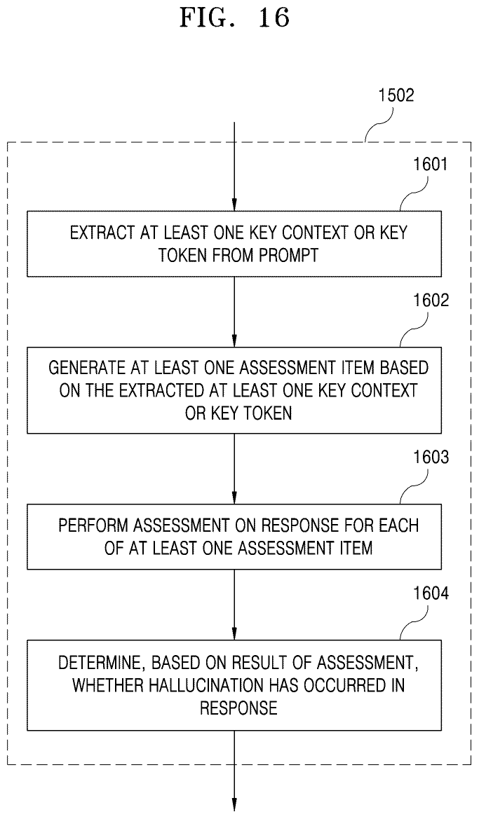

In operation 1502, the electronic apparatus may determine whether a hallucination has occurred in the response based on a context included in the prompt. Detailed operations included in operation 1502 are illustrated in FIG. 16.

Referring to FIG. 16, in operation 1601, the electronic apparatus may extract at least one key context or key token from the prompt. A key context may refer to an important context among contexts included in the prompt. The key context may be a context that directly affects the generation of the response. Therefore, the key context may be used to determine whether a hallucination has occurred in the response. A key token may refer to an important token among tokens included in the prompt and may be extracted from a key context. The key token may also be a token that directly affects the generation of the response. Therefore, the key token may be used to determine whether a hallucination has occurred in the response. Criteria or rules for extracting the key context or key token from the prompt may be preset.

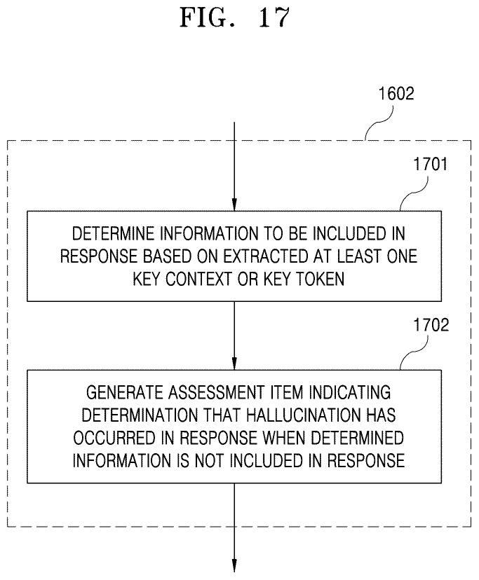

In operation 1602, the electronic apparatus may generate at least one assessment item based on the extracted at least one key context or key token. Detailed operations included in operation 1602 are illustrated in FIG. 17.

Referring to FIG. 17, in operation 1701, the electronic apparatus may determine information to be included in the response based on the extracted at least one key context or key token. In operation 1702, the electronic apparatus may generate an assessment item for determining that a hallucination has occurred in the response when the determined information is not included in the response.

In addition, the electronic apparatus may generate an assessment item for determining that a hallucination has occurred when the response does not include content corresponding to the extracted at least one key context or key token. Alternatively, the electronic apparatus may generate an assessment item for determining that a hallucination has occurred when the response includes content that is inconsistent with the extracted at least one key context or key token. Alternatively, the electronic apparatus may he electronic apparatus may identify, based on the extracted at least one key context or key token, a reference document used when generating the response, and generate an assessment item for determining that a hallucination has occurred when the response includes content that is inconsistent with the reference document.

Referring back to FIG. 16, in operation 1603, the electronic apparatus may perform an assessment on the response for each of the at least one assessment item. In operation 1604, the electronic apparatus may determine, based on a result of the assessments, whether a hallucination has occurred in the response.

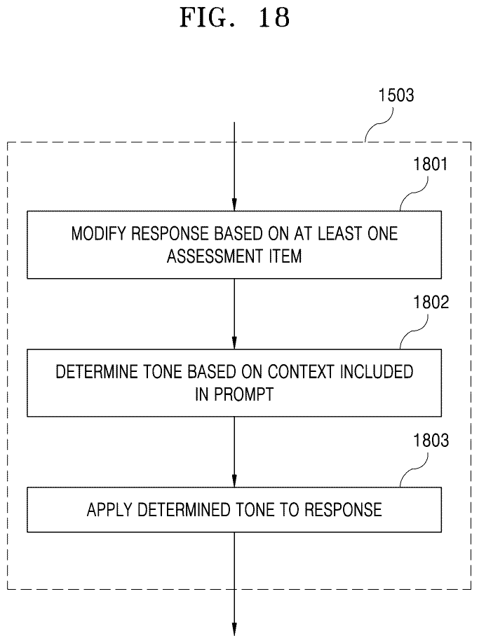

Referring back to FIG. 15, in operation 1503, when hallucination has occurred in the response, the electronic apparatus may modify the response and output a modified response. Detailed operations included in operation 1503 are illustrated in FIG. 18.

Referring to FIG. 18, in operation 1801, the electronic apparatus may modify the response based on the at least one assessment item. For example, the electronic apparatus may modify the response to include a key context or key token. Alternatively, for example, the electronic apparatus may modify the response to satisfy a condition required by an assessment item.

In operation 1802, the electronic apparatus may determine a tone based on the context included in the prompt. The electronic apparatus may determine a tone to be applied to the response based on one or more factors that are to be determined or predicted based on the context in the prompt. For example, the electronic apparatus may determine a tone based on a target to whom the response is to be provided. Alternatively, for example, the electronic apparatus may determine a tone to be applied to the response based on a tone of the prompt. Alternatively, for example, the electronic apparatus may determine a tone to be applied to the response based on a request in the prompt.

In operation 1803, the electronic apparatus may apply the determined tone to the response.

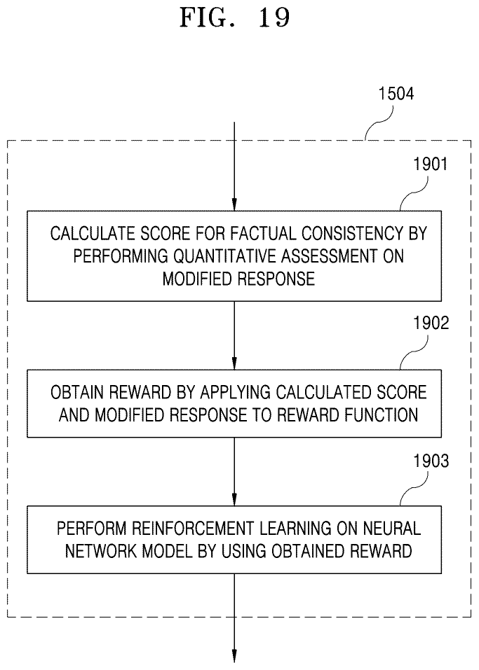

Referring back to FIG. 15, in operation 1504, the electronic apparatus may train or re-train the neural network model based on the modified response. Detailed operations included in operation 1504 are illustrated in FIG. 19.

Referring to FIG. 19, in operation 1901, the electronic apparatus may calculate a score for factual consistency by performing a quantitative assessment on the modified response.

In operation 1902, the electronic apparatus may obtain a reward by applying the calculated score and the modified response to a reward function. In this case, the reward function used may be a function that calculates a score by quantifying the faithfulness, harmlessness, and usefulness of the modified response. The electronic apparatus may obtain a score that quantifies the quality of the response or the modified response by using the reward function.

In operation 1903, the electronic apparatus may perform reinforcement learning on the neural network model by using the obtained reward. The electronic apparatus may update parameters included in the neural network model so as to increase the reward.

According to the embodiments of the disclosure described above, the electronic apparatus may determine whether a hallucination has occurred in a response based on a context included in a prompt, thereby allowing fast and accurate detection of the hallucination. Furthermore, the electronic apparatus modifies a response to remove the detected hallucination therefrom and outputs the modified response, thereby improving the quality of a service provided via a neural network model.

A method of removing a hallucination in a result of inference by a neural network model, according to an embodiment of the disclosure, may include obtaining a response of the neural network model by inputting a prompt to the neural network model, determining, based on a context included in the prompt, whether a hallucination has occurred in the response, and when the hallucination has occurred in the response, modifying the response and outputting the modified response.

According to an embodiment of the disclosure, the determining may include extracting at least one key context or key token from the prompt, generating at least one assessment item based on the extracted at least one key context or key token, performing an assessment on the response for each of the at least one assessment item, and determining, based on a result of the assessments, whether the hallucination has occurred in the response.

According to an embodiment of the disclosure, the generating of the at least one assessment item may include determining information to be included in the response based on the extracted at least one key context or key token, and generating an assessment item for determining the hallucination has occurred in the response when the determined information is not included in the response.

According to an embodiment of the disclosure, the generating of the at least one assessment item may include generating an assessment item for determining that the hallucination has occurred in the response when the response does not include content corresponding to the extracted at least one key context or key token.

According to an embodiment of the disclosure, the generating of the at least one assessment item may include generating an assessment item for determining that the hallucination has occurred in the response when the response includes content that is inconsistent with the extracted at least one key context or key token.

According to an embodiment of the disclosure, the generating of the at least one assessment item may include identifying, based on the extracted at least one key context or key token, a reference document used when generating the response, and generating an assessment item for determining that the hallucination has occurred when the response includes content that is inconsistent with the reference document.

According to an embodiment of the disclosure, the method may further include additionally training the neural network model based on the modified response.

According to an embodiment of the disclosure, the additional training of the neural network model may include retraining the neural network model by using training data including the prompt and the modified response.

According to an embodiment of the disclosure, the additional training of the neural network may include calculating a score for factual consistency by performing a quantitative assessment on the modified response, obtaining a reward by inputting the calculated score and the modified response to a reward function, and performing reinforcement learning on the neural network model by using the obtained reward.

According to an embodiment of the disclosure, the modifying of the response and the outputting of the modified response may include modifying the response based on the at least one assessment item, determining a tone based on the context included in the prompt, and applying the determined tone to the response.

An electronic apparatus according to an embodiment of the disclosure may include an I/O interface receiving a prompt to be input to a neural network model and outputting a response of the neural network model in response to the prompt, a memory storing a program or instruction for detecting a hallucination in the response, and at least one processor configured to execute the program or instruction stored in the memory to cause the electronic apparatus to obtain the response of the neural network model by inputting the prompt to the neural network model, determine, based on a context included in the prompt, whether a hallucination has occurred in the response, and when the hallucination has occurred in the response, modify the response and output the modified response.

According to an embodiment of the disclosure, in the determining of whether the hallucination has occurred, the electronic apparatus may be configured to extract at least one key context or key token from the prompt, generate at least one assessment item based on the extracted at least one key context or key token, perform an assessment on the response for each of the at least one assessment item, and determine, based on a result of the assessments, whether the hallucination has occurred in the response.

According to an embodiment of the disclosure, in the generating of the at least one assessment item, the electronic apparatus may be configured to determine information to be included in the response based on the extracted at least one key context or key token, and then generate an assessment item for determining that the hallucination has occurred in the response when the determined information is not included in the response.

According to an embodiment of the disclosure, in the generating of the at least one assessment item, the electronic apparatus may be configured to generate an assessment item for determining that the hallucination has occurred in the response when the response does not include content corresponding to the extracted at least one key context or key token.

According to an embodiment of the disclosure, in the generating of the at least one assessment item, the electronic apparatus may be configured to generate an assessment item for determining that the hallucination has occurred in the response when the response includes content that is inconsistent with the extracted at least one key context or key token.

According to an embodiment of the disclosure, in the generating of the at least one assessment item, the electronic apparatus may be configured to identify, based on the extracted at least one key context or key token, a reference document used when generating the response, and generate an assessment item for determining that the hallucination has occurred when the response includes content that is inconsistent with the reference document.

According to an embodiment of the disclosure, the at least one processor is further configured to execute the program or instruction to cause the electronic apparatus to additionally train the neural network model based on the modified response.

According to an embodiment of the disclosure, in the additional training of the neural network model, the electronic apparatus may be configured to retrain the neural network model by using training data including the prompt and the modified response.

According to an embodiment of the disclosure, in the additional training of the neural network model, the electronic apparatus may be configured to calculate a score for factual consistency by performing a quantitative assessment on the modified response, obtain a reward by applying the calculated score and the modified response to a reward function, and perform reinforcement learning on the neural network model by using the obtained reward.

Various embodiments of the disclosure may be implemented or supported by one or more computer programs that may be created from computer-readable program code and included on computer-readable media. As used herein, the terms “application” and “program” may refer to one or more computer programs, software components, instruction sets, procedures, functions, objects, classes, instances, associated data, or parts thereof suitable for implementation in computer-readable program code. The “computer-readable program code” may include various types of computer code, including source code, object code, and executable code. The “computer-readable media” may include various types of media that are accessible by a computer, such as ROM, RAM, hard disk drives (HDDs), CDs, DVDs, or various other types of memory.

Furthermore, a machine-readable storage medium may be provided in the form of a non-transitory storage medium. Here, the ‘non-transitory storage medium’ is a tangible device and may exclude wired, wireless, optical, or other communication links that transmit transient electrical or other signals. Moreover, the term ‘non-transitory storage medium’ does not differentiate between where data is semi-permanently stored in the storage medium and where the data is temporarily stored in the storage medium. For example, the ‘non-transitory storage medium’ may include a buffer for temporarily storing data. The computer-readable media may be any available media that are accessible by a computer and include both volatile and nonvolatile media and both removable and non-removable media. The computer-readable media include media on which data may be permanently stored and media on which data may be stored and overwritten later, such as rewritable optical disks or erasable memory devices.

According to an embodiment of the disclosure, methods according to various embodiments of the disclosure set forth herein may be included in a computer program product when provided. The computer program product may be traded, as a product, between a seller and a buyer. The computer program product may be distributed in the form of a machine-readable storage medium (e.g., compact disc ROM (CD-ROM)) or distributed (e.g., downloaded or uploaded) on-line via an application store or directly between two user devices (e.g., smartphones). For online distribution, at least a part of the computer program product (e.g., a downloadable app) may be at least transiently stored or temporally generated in a machine-readable storage medium such as a memory of a server of a manufacturer, a server of an application store, or a relay server.

The above description of the disclosure is provided for illustration, and it will be understood by those of ordinary skill in the art that changes in form and details may be readily made therein without departing from technical idea or essential characteristics of the disclosure. For example, adequate effects may be achieved even when the above-described techniques are performed in a different order than that described above, and/or the aforementioned components of the systems, structures, devices, circuitry, etc. are coupled or combined in different forms and modes than those described above or are replaced or supplemented by other components or their equivalents. Accordingly, the above-described embodiments of the disclosure and all aspects thereof are merely examples and are not limiting. For example, each component defined as an integrated component may be implemented in a distributed fashion, and likewise, components defined as separate components may be implemented in an integrated form.

The scope of the disclosure is defined not by the detailed description thereof but by the following claims, and all the changes or modifications within the meaning and scope of the appended claims and their equivalents will be construed as being included in the scope of the disclosure.

What is claimed is:

1. A method, executed by at least one processor including processing circuitry, individually or collectively, the method comprising:
obtaining a response of a neural network model based on a prompt provided to the neural network model;
determining, based on a context comprised in the prompt, whether a hallucination has occurred in the response; and
based on determining that the hallucination has occurred, modifying the response and outputting the modified response.

2. The method of claim 1, wherein
the determining whether the hallucination has occurred comprises:
extracting at least one key context or at least one key token from the prompt;
generating at least one assessment item based on the at least one key context or the at least one key token;
performing an assessment on the response for each of the at least one assessment item; and
determining, based on the assessment, whether the hallucination has occurred in the response.

3. The method of claim 2, wherein
the generating of the at least one assessment item comprises:
determining information to be included in the response based on the at least one key context or the at least one key token; and
generating the at least one assessment item for determining that the hallucination has occurred in the response when the determined information is not included in the response.

4. The method of claim 2, wherein the generating of the at least one assessment item comprises generating the at least one assessment item for determining that the hallucination has occurred is based on the response not including content corresponding to the at least one key context or the at least one key token.

5. The method of claim 2, wherein the generating of the at least one assessment item comprises generating the at least one assessment item for determining that the hallucination has occurred is based on the response including content that is inconsistent with the at least one key context or the at least one key token.

6. The method of claim 2, wherein
the generating the at least one assessment item comprises:
identifying, based on the at least one key context or the at least one key token, a reference document used when generating the response; and
generating the at least one assessment item for determining that the hallucination has occurred is based on the response including content that is inconsistent with the reference document.

7. The method of claim 1, further comprising training the neural network model based on the modified response.

8. The method of claim 7, wherein the training of the neural network model comprises retraining the neural network model using training data that comprises the prompt and the modified response.

9. The method of claim 7, wherein
the training of the neural network model comprises:
calculating a score associated with factual consistency based on a quantitative assessment on the modified response;
obtaining a reward based on the score, the modified response, and a reward function; and
performing reinforcement learning on the neural network model based on the reward.

10. The method of claim 2, wherein
the modifying of the response and the outputting of the modified response comprises:
modifying the response based on the at least one assessment item;
determining a tone based on the context comprised in the prompt; and
applying the tone to the response.

11. A non-transitory computer-readable medium storing one or more instructions, the one or more instructions, when executed by one or more processors, causes the one or more processors to:
obtain a response of a neural network model based on a prompt to the neural network model;
determine, based on a context comprised in the prompt, whether a hallucination has occurred in the response; and
based on determining that the hallucination has occurred, modify the response and outputting the modified response.

12. An electronic apparatus comprising:
an input/output interface configured to receive a prompt to be input to a neural network model and configured to output a response of the neural network model in response to the prompt;
a memory storing one or more instructions for detecting a hallucination in the response; and
at least one processor comprising processing circuitry,
wherein the one or more instructions are configured to, when executed by the at least one processor individually or collectively, cause the electronic apparatus to:
obtain the response of the neural network model based on the prompt provided to the neural network model,
determine, based on a context comprised in the prompt, whether a hallucination has occurred in the response, and
based on determining that the hallucination has occurred, modify the response and output the modified response.

13. The electronic apparatus of claim 12, wherein
in the determining of whether the hallucination has occurred, the electronic apparatus is configured to
extract at least one key context or at least one key token from the prompt,
generate at least one assessment item based on the at least one key context or the at least one key token,
perform an assessment on the response for each of the at least one assessment item, and
determine, based on the assessment, whether the hallucination has occurred in the response.

14. The electronic apparatus of claim 13, wherein
in the generating of the at least one assessment item, the electronic apparatus is configured to
determine information to be included in the response based on the at least one key context or the at least one key token, and
generate the at least one assessment item for determining that the hallucination has occurred in the response when the determined information is not included in the response.

15. The electronic apparatus of claim 13, wherein in the generating of the at least one assessment item, the electronic apparatus is configured to generate the at least one assessment item for determining that the hallucination has occurred is based on the response not including content corresponding to the at least one key context or the at least one key token.

16. The electronic apparatus of claim 13, wherein in the generating of the at least one assessment item, the electronic apparatus is configured to generate the at least one assessment item for determining that the hallucination has occurred is based on the response including content that is inconsistent with the at least one key context or the at least one key token.

17. The electronic apparatus of claim 13, wherein
in the generating of the at least one assessment item, the electronic apparatus is configured to
identify, based on the at least one key context or the at least one key token, a reference document used when generating the response, and
generate the at least one assessment item for determining that the hallucination has occurred based on the response including content that is inconsistent with the reference document.

18. The electronic apparatus of claim 12, wherein the one or more instructions are further configured to, when executed by the at least one processor individually or collectively, cause the electronic device to train the neural network model based on the modified response.

19. The electronic apparatus of claim 18, wherein in the training of the neural network model, the electronic apparatus is configured to retrain the neural network model using training data including the prompt and the modified response.

20. The electronic apparatus of claim 18, wherein
in the training of the neural network model, the electronic apparatus is configured to
calculate a score associated with factual consistency based on a quantitative assessment on the modified response,
obtain a reward based on the score, the modified response, and a reward function, and
perform reinforcement learning on the neural network model based on the reward.
